(19) United States
(12) Patent Application Publication
(10) Pub. No.: US 2021/0152812 A1
(43) Pub. Date: May 20, 2021

(54) DISPLAY CONTROL DEVICE, DISPLAY SYSTEM, AND DISPLAY CONTROL METHOD

(71) Applicant: MITSUBISHI ELECTRIC CORPORATION, Tokyo (JP)

(72) Inventors: Shuhei OTA, Tokyo (JP); Kiyotaka KATO, Tokyo (JP)

(73) Assignee: MITSUBISHI ELECTRIC CORPORATION, Tokyo (JP)

(21) Appl. No.: 16/627,474

(22) PCT Filed: Jul. 24, 2017
(86) PCT No.: PCT/JP2017/026664

§ 371 Date: Dec. 30, 2019

(51) Int. Cl. H04N 13/366; H04N 13/302; G02B 27/01; G02B 27/00; B60K 35/00

(52) U.S. Cl. CPC H04N 13/366; H04N 13/302; G02B 27/0179; B60K 2370/1529; B60K 35/00; G02B 2027/0187; G02B 27/0093

(57) ABSTRACT

An image generating unit generates an image and causes a display device to display the image. An eye position information acquiring unit acquires position information of the left eye and the right eye of an observer. A stereoscopic viewing area controlling unit specifies the position of stereoscopic viewing areas on the basis of the rotation angle of a projection mechanism adjusting unit for rotating a projection plane about a vertical axis and adjusts the position of the stereoscopic viewing areas by instructing the projection mechanism adjusting unit to rotate the projection plane about the vertical axis depending on the position information of the left eye and the right eye of the observer.

### TECHNICAL FIELD

The present invention relates to a display control device which enables stereoscopic vision of an image displayed on a display device, a display system including the display control device, and a display control method.

### BACKGROUND ART

In the related art, there are display devices that enable stereoscopic vision of binocular parallax images using two different images (hereinafter referred to as binocular parallax images) in which parallax is given for the left eye and the right eye of an observer.

For example, Patent Literature 1 describes a three-dimensional display mounted on a vehicle and capable of exhibiting a stereoscopic image to an occupant. This three-dimensional display includes a parallax barrier arranged close to the display surface.

The parallax barrier separates an image displayed on the display surface into a left-eye portion and a right-eye portion, and blocks the right-eye portion of the image from the left eye of the occupant and the left-eye portion of the image from the right eye of the occupant. The parallax barrier causes the left eye of the occupant to look at the left-eye portion of the image and the right eye of the occupant looks at the right-eye portion of the image while the three-dimensional display is directed toward the head of the occupant. As a result, the occupant can visually recognize a stereoscopic image.

In the three-dimensional display described in Patent Literature 1, an axis perpendicular to the display surface is directed toward the head of the occupant. As a result, the left-eye portion of the image is directed to the left eye of the occupant, and the right-eye portion of the image is directed to the right eye of the occupant. However, when the position of the head of the occupant changes, the positional relationship between the parallax barrier and the orientation of the head of the occupant changes, thereby preventing the occupant from visually recognizing the stereoscopic image.

In order to solve this disadvantage, a vehicle display assembly described in Patent Literature 1 includes an actuator for adjusting the orientation of the three-dimensional display, a sensor assembly for monitoring the position of the head of the occupant, and a controller for controlling the sensor assembly and the actuator. The controller controls the actuator and the sensor assembly to adjust the orientation of the three-dimensional display on the basis of the position of head of the occupant.

Meanwhile, a head-up display (hereinafter, abbreviated as HUD) is a display device that allows an observer to visually recognize display information without significantly moving the line of sight from the front visual field.

Also known in the related art are HUDs that enable stereoscopic vision of a display image based on binocular parallax.

For example, in an HUD mounted on a vehicle, display light of an image displayed on a screen is split into display light of a left-eye image and display light of a right-eye image, which are then projected on a projected plane such as a windshield glass or a combiner. With the display light of the left-eye image reflected by the projected plane being incident on the driver's left eye and the display light of the right-eye image reflected by the projected plane being incident on the driver's right eye, the driver can visually recognize a stereoscopic image formed in front of the vehicle. Unlike ordinary three-dimensional displays, an HUD that enables stereoscopic vision of a display image based on binocular parallax needs to split display light in consideration of a projection optical system such as a reflection plane and a projected plane.

### CITATION LIST

### Patent Literature

Patent Literature 1: JP 2016-510518 A

### SUMMARY OF INVENTION

### Technical Problem

In order to cause an observer to stereoscopically view an image, it is necessary to consider a range for causing the left eye of the observer to observe a left-eye image and a range for causing the right eye of the observer to observe a right-eye image. This range is referred to as a “stereoscopic viewing area.” The left eye of the observer observes a stereoscopic image of the left-eye image within a left-eye stereoscopic viewing area, and the right eye of the observer observes a stereoscopic image of the right-eye image within a right-eye stereoscopic viewing area, thereby allowing the observer to visually recognize a stereoscopic image of the binocular parallax images.

However, in a case where stereoscopic viewing areas are fixed at a certain position, there are possibilities that the observer's eyes deviate from the stereoscopic viewing areas or that the observer's eyes are positioned near the boundary of the stereoscopic viewing areas depending on the physique or the posture of the observer. As described above, when the observer's eyes deviate from the stereoscopic viewing area, the observer cannot stereoscopically view the image. Moreover, although the observer's eyes are positioned close to the boundary of the stereoscopic viewing areas, the observer's eyes will be out of the stereoscopic viewing areas with only a slight movement of the observer's head.

Meanwhile, some conventional three-dimensional displays adjust the position of stereoscopic viewing areas by dynamically controlling a spectroscopic mechanism disposed in front of a display screen depending on the position of the observer's eyes. The spectroscopic mechanism includes a fence-like member called a barrier or a lenticular lens, and splits display light of binocular parallax images displayed on the screen into display light of a left-eye image and display light of a right-eye image. Thus, a complicated mechanism for dynamically controlling a spectroscopic mechanism is required in conventional three-dimensional displays, and thus a spectroscopic mechanism becomes highly costly.

Meanwhile, the vehicle display assembly described in Patent Literature 1 adjusts the orientation of the three-dimensional display and thus is not applicable as it is to the position adjustment of stereoscopic viewing areas of an HUD which needs consideration to the optical design of a projection system.

The present invention solves the above-mentioned disadvantages, and an object of the present invention is to obtain a display control device, a display system, and a display control method capable of adjusting the position of stereoscopic viewing areas depending on the position of the eyes of an observer with a configuration simpler than a configuration for controlling a spectroscopic mechanism.

### Solution to Problem

A display control device according to the present invention is a display control device for a display device including: a projection mechanism for projecting display light of an image from a projection plane; a spectroscopic mechanism for splitting the display light into a left-eye image and a right-eye image; and a projection mechanism adjusting unit for adjusting a projection direction of the projection mechanism, in which the display device causes an observer to stereoscopically view binocular parallax images by forming stereoscopic viewing areas for a left eye and a right eye, in which a stereoscopic image projected onto a projected plane can be visually recognized, causing the left eye of the observer to visually recognize the stereoscopic image of the left-eye image as a binocular parallax image in the stereoscopic viewing area for the left eye, and causing the right eye of the observer to visually recognize the stereoscopic image of the right-eye image as a binocular parallax image in the stereoscopic viewing area for the right eye, the display control device including: an image generating unit for generating the image and causing the display device to display the image; an eye position information acquiring unit for acquiring position information of the left eye and the right eye of the observer; and a control unit for specifying positions of the stereoscopic viewing areas for the left eye and the right eye on the basis of a rotation angle of the projection mechanism adjusting unit that rotates the projection plane about a rotation axis passing through a center position of the projection plane of the projection mechanism and adjusting the positions of the specified stereoscopic viewing areas for the left eye and the right eye by instructing the projection mechanism adjusting unit to rotate the projection plane about the rotation axis depending on the position information of the left eye and the right eye of the observer acquired by the eye position information acquiring unit.

### Advantageous Effects of Invention

According to the invention, by rotating a projection plane about a rotation axis passing through the center position of the projection plane of a projection mechanism, the positions of the stereoscopic viewing areas for the left eye and the right eye are adjusted depending on position information of the left eye and the right eye of an observer. With this configuration, the positions of stereoscopic viewing areas can be adjusted depending on the positions of the eyes of an observer with a configuration simpler than a configuration for controlling a spectroscopic mechanism.

### BRIEF DESCRIPTION OF DRAWINGS

FIG. 1 is a functional block diagram illustrating a configuration of a display system according to a first embodiment of the invention.

FIG. 2 is a diagram schematically illustrating a configuration of a display system according to the first embodiment mounted on a vehicle.

FIG. 3 is a diagram illustrating an example of a projection mechanism and a spectroscopic mechanism.

FIG. 4 is a diagram illustrating an outline of position adjustment of stereoscopic viewing areas by a projection mechanism adjusting unit.

FIG. 5A is a block diagram illustrating a hardware configuration for implementing the function of a display control device according to the first embodiment.

FIG. 5B is a block diagram illustrating a hardware configuration for executing software that implements functions of the display control device according to the first embodiment.

FIG. 6 is a flowchart illustrating a display control method according to the first embodiment.

FIG. 7 is a functional block diagram illustrating a configuration of a display system according to a second embodiment of the invention.

FIG. 8 is a diagram schematically illustrating a configuration of a display system according to the second embodiment mounted on a vehicle.

FIG. 9 is a diagram illustrating an outline of position adjustment of a stereoscopic viewing area by a projection mechanism adjusting unit and a reflection mirror adjusting unit of the second embodiment.

FIG. 10 is a flowchart illustrating a display control method according to the second embodiment.

FIG. 11 is a top view illustrating stereoscopic viewing areas formed on a driver side.

FIG. 12 is a top view illustrating a situation where the driver's head is shifted to the right in the stereoscopic viewing areas of FIG. 11.

FIG. 13 is a top view illustrating an outline of control processing by an image generating unit in a third embodiment.

FIG. 14 is a flowchart illustrating a display control method according to the third embodiment.

### DESCRIPTION OF EMBODIMENTS

To describe the invention further in detail, embodiments for carrying out the invention will be described below with reference to the accompanying drawings.

### First Embodiment

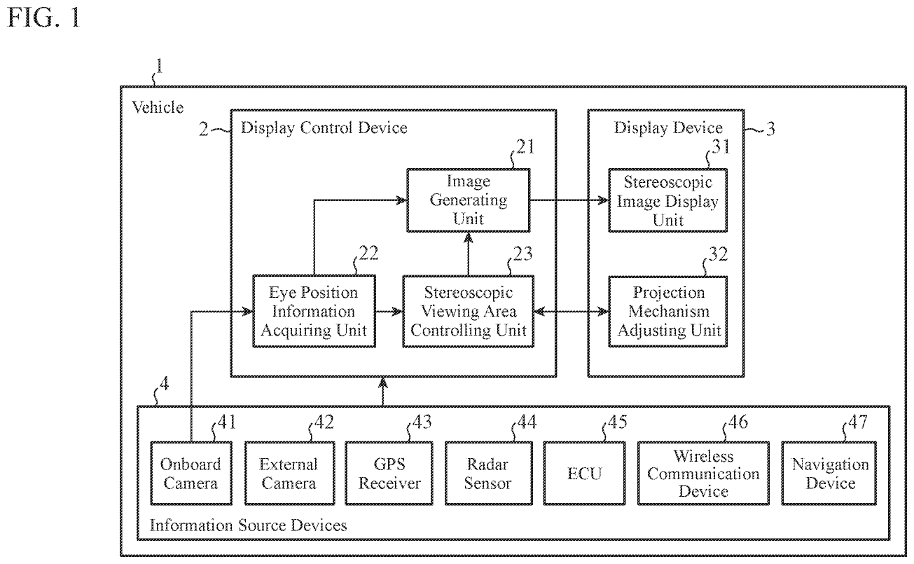

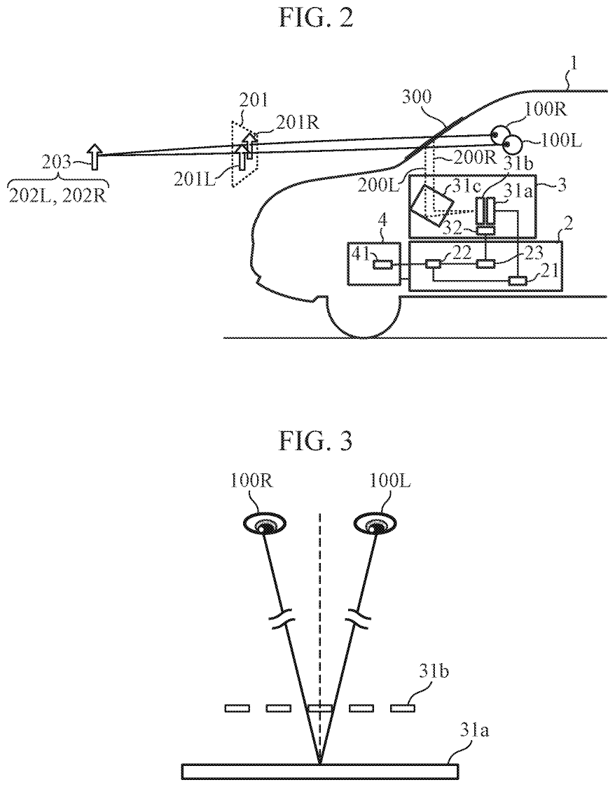

FIG. 1 is a functional block diagram illustrating a configuration of a display system according to a first embodiment of the invention. FIG. 2 is a diagram schematically illustrating a configuration of a display system according to the first embodiment mounted on a vehicle 1 and illustrates a case where the display system of the first embodiment is implemented as an HUD system. The display system according to the first embodiment includes a display control device 2 and a display device 3 as illustrated in FIGS. 1 and 2. The display control device 2 is capable of obtaining information of the inside and the outside of the vehicle from information source devices 4.

Image information generated by the display control device 2 is output to the display device 3. The display device 3 projects display light of an image input from the display control device 2 onto a windshield glass (hereinafter referred to as a windshield) 300. With the display light reflected by the windshield 300 entering the left eye 100L and the right eye 100R of a driver, the driver can visually recognize a stereoscopic image 201 of the image.

The display control device 2 includes an image generating unit 21, an eye position information acquiring unit 22, and a stereoscopic viewing area controlling unit 23. The display device 3 includes a stereoscopic image display unit 31 and a projection mechanism adjusting unit 32. The information source devices 4 is a generic name of devices which are mounted on the vehicle 1 and provide the display control device 2 with information of the inside and the outside of the vehicle. In FIG. 1, the information source devices 4 are exemplified by an onboard camera 41, an external camera 42, a global positioning system (GPS) receiver 43, a radar sensor 44, an electronic control unit (ECU) 45, a wireless communication device 46, and a navigation device 47.

First, components of the display control device 2 will be described.

The image generating unit 21 generates an image and causes the stereoscopic image display unit 31 to display the image. For example, the image generating unit 21 acquires image information from the onboard camera 41 and the external camera 42, acquires position information of the vehicle 1 from the GPS receiver 43, acquires various types of vehicle information from the ECU 45, and acquires navigation information from the navigation device 47. Using these pieces of information, the image generating unit 21 generates image information including display objects indicating the traveling speed of the vehicle 1, the lane in which the vehicle 1 is traveling, the position of a vehicle present around the vehicle 1, and the current position and the traveling direction of the vehicle 1.

The image generating unit 21 may also generate binocular parallax images. The binocular parallax images include images in which a display object is shifted in the left-right direction, that is, a left-eye image and a right-eye image in which parallax is given for the left eye and the right eye of an observer.

The eye position information acquiring unit 22 acquires position information of the left eye and the right eye of the observer. For example, the eye position information acquiring unit 22 acquires position information of the driver's left eye 100L and the right eye 100R by analyzing an image of the driver captured by the onboard camera 41.

The position information of the left eye 100L and the right eye 100R of the driver may be position information of each of the left eye 100L and the right eye 100R, or may be the central position between the left eye 100L and the right eye 100R. Moreover, as the central position between the left eye 100L and the right eye 100R, a position estimated from the face position or the head position of the driver in the image may be used.

The stereoscopic viewing area controlling unit 23 controls the projection mechanism adjusting unit 32 to adjust the position of stereoscopic viewing areas. First, the stereoscopic viewing area controlling unit 23 identifies the position of stereoscopic viewing areas for the left eye and the right eye on the basis of the rotation angle of the projection mechanism adjusting unit 32 with respect to a reference position of a projection plane about the vertical axis passing through the center position of a projection plane of a projection mechanism 31a. The reference position is the origin position of the rotation of the projection plane.

The position of the stereoscopic viewing areas for the left eye and the right eye may be, for example, the position coordinates of an intersection point of the central axis (vertical central axis) of the space in which the stereoscopic viewing areas are formed and the horizontal plane that includes the left eye 100L and the right eye 100R of a driver.

Alternatively, the position of the stereoscopic viewing areas for the left eye and the right eye may be the position coordinates of the midpoint of the line segment connecting the above intersection point of the stereoscopic viewing area for the left eye and the above intersection point of the stereoscopic viewing area for the right eye.

The stereoscopic viewing area controlling unit 23 instructs the projection mechanism adjusting unit 32 to rotate the projection plane about the vertical axis to adjust the positions of the stereoscopic viewing areas for the left eye and the right eye depending on the position information of the left eye 100L and the right eye 100R of the driver acquired by the eye position information acquiring unit 22.

For example, the stereoscopic viewing area controlling unit 23 instructs the projection mechanism adjusting unit 32 to rotate the projection plane about the vertical axis in such a manner that the deviation amount between the positions of the stereoscopic viewing areas for the left eye and the right eye and the positions of the left eye 100L and the right eye 100R of the driver becomes less than or equal to a first threshold value. The first threshold value is a threshold value related to the deviation amount that is adjustable by rotation of the projection plane about the vertical axis by the projection mechanism adjusting unit 32 and is, for example, a tolerable value of the deviation amount.

When the projection plane is rotated about the vertical axis so that the position of the stereoscopic viewing areas for the left eye and the right eye coincides with the positions of the left eye 100L and the right eye 100R of the driver, the deviation amount becomes lower than or equal to the first threshold value. At this time, the driver's left eye 100L is positioned near the center of the left stereoscopic viewing area, and the driver's right eye 100R is positioned near the center of the right stereoscopic viewing area. Thus, the driver can stereoscopically view the binocular parallax images even when the head moves a little.

Next, components of the display device 3 will be described.

The stereoscopic image display unit 31 receives an image generated by the image generating unit 21 as an input and projects display light of the input image on a projected plane. In the example of FIG. 2, the projected plane is the windshield 300. Note that the projected plane may be a semitransparent mirror called a combiner.

As illustrated in FIG. 2, the stereoscopic image display unit 31 includes the projection mechanism 31a, a spectroscopic mechanism 31b, and a reflection mirror 31c.

The projection mechanism 31a is a component that projects display light of an image from a projection plane, and includes a display device capable of projecting display light of an image from the display plane (projection plane). As the projection mechanism 31a, for example, a display such as liquid crystal, a projector, or a laser light source is used. Note that in a liquid crystal display, a backlight serving as a light source is required. The backlight may rotate together with the projection mechanism 31a by the projection mechanism adjusting unit 32. Alternatively, the backlight may not rotate, and only the projection mechanism 31a may rotate.

The spectroscopic mechanism 31b splits the display light of the image projected from the projection mechanism 31a into display light of a left-eye image 200L and display light of a right-eye image 200R. The spectroscopic mechanism 31b includes a parallax barrier or a lenticular lens.

The reflection mirror 31c reflects the display light of the image projected from the projection mechanism 31a toward the windshield 300 which is a projected plane.

The display light of the left-eye image 200L and the display light of the right-eye image 200R are reflected by the windshield 300 toward the driver. At this time, the left-eye image 200L is formed as a left-eye stereo image 201L, and the right-eye image 200R is formed as a right-eye stereo image 201R. Thus, the driver can visually recognize a stereoscopic display object 203 (a display object 202L of the left-eye stereo image 201L and a display object 202R of the right-eye stereo image 201R) at an intersecting position of the straight line passing through the left eye 100L and the left-eye stereo image 201L and the straight line passing through the right eye 100R and the right-eye stereo image 201R.

FIG. 3 is a diagram illustrating an example of the projection mechanism 31a and the spectroscopic mechanism 31b. Light emitted from a pixel of the projection plane of the projection mechanism 31a is split by the spectroscopic mechanism 31b and emitted in directions toward each eye. At this time, the observer can visually recognize only the light having passed through openings of the spectroscopic mechanism 31b. An area in which the pixels of the stereoscopic image can be visually recognized without a missing pixel is a stereoscopic viewing area, which is formed by light likewise emitted from each of all the pixels, split by the spectroscopic mechanism 31b, and emitted in the directions of each eye.

Note that the configuration in which the spectroscopic mechanism 31b spatially splits into the display light of the left-eye image 200L and the display light of the right-eye image 200R has been described; however, the spectroscopy may be performed temporally.

Moreover, the projection mechanism 31a and the spectroscopic mechanism 31b may be integrated.

The stereoscopic image display unit 31 may not include the reflection mirror 31c and may project display light of an image directly from the spectroscopic mechanism 31b toward the windshield 300.

In FIG. 3, the display light of the left-eye image 200L and the display light of the right-eye image 200R are alternately emitted for each pixel (or each sub-pixel) of the projection plane and are split by the spectroscopic mechanism 31b. Note that the display device 3 is not limited to such a display device of the dual viewpoint system, and a multiple viewpoint system may be employed. For example, display light of parallax images including three or more images having different parallaxes may be projected from the projection plane of the projection mechanism 31a and may be split into three or more viewpoints by the spectroscopic mechanism 31b.

The projection mechanism adjusting unit 32 is a component that adjusts the projection direction of the projection mechanism 31a, and is, for example, a motor that rotates a projection plane 31a-1.

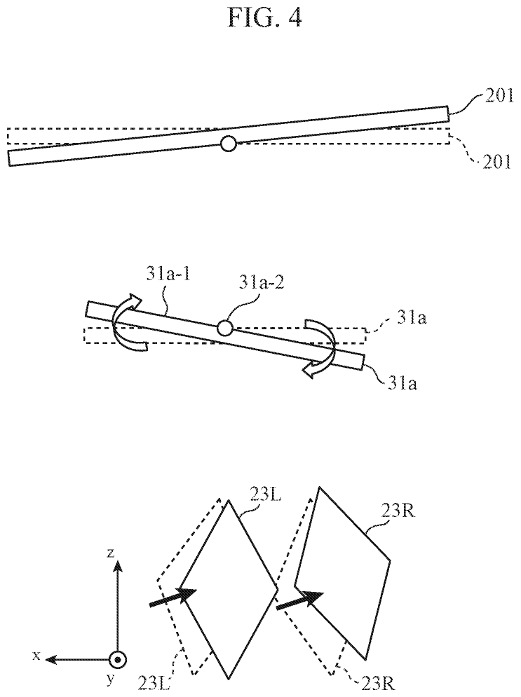

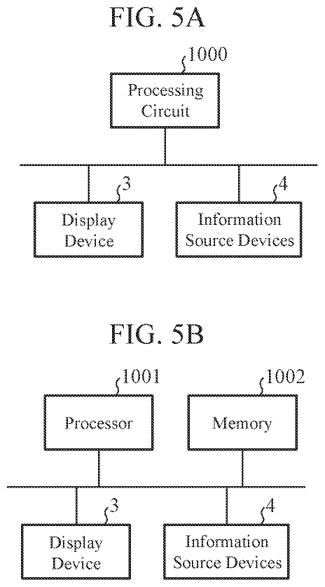

FIG. 4 is a diagram illustrating an outline of position adjustment of stereoscopic viewing areas by the projection mechanism adjusting unit 32.

The projection mechanism adjusting unit 32 rotates the projection plane 31a-1 about a vertical axis (axis in the y direction in FIG. 4) 31a-2 passing through the center position of the projection plane 31a-1 of the projection mechanism 31a.

When the projection plane 31a-1 rotates about the vertical axis 31a-2, the stereoscopic image 201 also rotates about the vertical axis accordingly. Depending on this rotation, a stereoscopic viewing area 23L for the left eye and a stereoscopic viewing area 23R for the right eye rotate as indicated by arrows to move in a left-right direction (x direction in FIG. 4) and a front-rear direction (z direction in FIG. 4). That is, it is possible to adjust the position of the stereoscopic viewing areas 23L and 23R in the left-right direction and the front-rear direction by rotation of the projection plane 31a-1 about the vertical axis 31a-2.

Note that the terms “perpendicular” and “vertical” have been used to describe the rotation axis and the moving direction; however, it is not always perpendicular or vertical depending on the structure of the vehicle or the HUD. The same applies to the following description as well.

Although the windshield type HUD in which the projected plane of display light of an image is the windshield 300 has been illustrated as the display device 3, the display device 3 may be a combiner type HUD having a projected plane being a combiner.

Alternatively, the display device 3 may be a display device capable of displaying a stereoscopic image such as a head mounted display (HMD).

Next, the information source devices 4 will be described.

The onboard camera 41 photographs a driver who corresponds to an observer among occupants of the vehicle 1. The image information captured by the onboard camera 41 is output to the eye position information acquiring unit 22 of the display control device 2. The eye position information acquiring unit 22 analyzes the image photographed by the onboard camera 41 to acquire position information of the left eye 100L and the right eye 100R of the driver.

The external camera 42 photographs the surroundings of the vehicle 1. For example, the external camera 42 photographs a lane in which the vehicle 1 is traveling, a vehicle present around the vehicle 1, and obstacles.

The image information captured by the external camera 42 is output to the display control device 2.

The GPS receiver 43 receives GPS signals from the GPS satellites (not illustrated) and outputs position information corresponding to the coordinates indicated by the GPS signals to the display control device 2.

The radar sensor 44 detects the direction and the shape of an object present outside the vehicle 1 and further detects the distance between the vehicle 1 and the object, and is implemented by, for example, a radio wave sensor of a millimeter wave band or an ultrasonic sensor. Information detected by the radar sensor 44 is output to the display control device 2.

The ECU 45 is a control unit for controlling various operations of the vehicle 1. The ECU 45 is connected to the display control device 2 by a wire harness (not illustrated) and is capable of communicating with the display control device 2 by a communication scheme based on the controller area network (CAN) standards. Vehicle information related to various operations of the vehicle 1 includes the vehicle speed and steering information and is output from the ECU 45 to the display control device 2.

The wireless communication device 46 is connected with an external network for communication to acquire various types of information, and is implemented by, for example, a transceiver mounted on the vehicle 1 or a portable communication terminal such as a smartphone carried into the vehicle 1. The external network is, for example, the Internet. The various types of information include weather information around the vehicle 1 and is output from the wireless communication device 46 to the display control device 2.

The navigation device 47 searches for a travel route of the vehicle 1 on the basis of set destination information, map information stored in a storage device (not illustrated), and position information acquired from the GPS receiver 43, and provides a guidance on a travel route selected from the search results. Note that illustration of a connection line between the GPS receiver 43 and the navigation device 47 is omitted in FIG. 1.

The navigation device 47 may be an information device mounted on the vehicle 1 or may be a portable communication device such as a portable navigation device (PND) or a smartphone brought into the vehicle 1.

The navigation device 47 outputs navigation information used for guidance of the travel route to the display control device 2. The navigation information includes, for example, the guidance direction of the vehicle 1 at a guidance point on the route, estimated arrival time to a transit point or the destination, and congestion information of the travel route of the vehicle 1 and its surrounding roads.

FIG. 5A is a block diagram illustrating a hardware configuration for implementing the function of the display control device 2. In FIG. 5A, a processing circuit 1000 can be connected to the display device 3 and the information source devices 4 to exchange information. FIG. 5B is a block diagram illustrating a hardware configuration for executing software that implements the function of the display control device 2. In FIG. 5B, a processor 1001 and a memory 1002 are connected to the display device 3 and the information source devices 4. The processor 1001 can exchange information with the display device 3 and the information source devices 4.

Each function of the image generating unit 21, the eye position information acquiring unit 22, and the stereoscopic viewing area controlling unit 23 in the display control device 2 is implemented by a processing circuit.

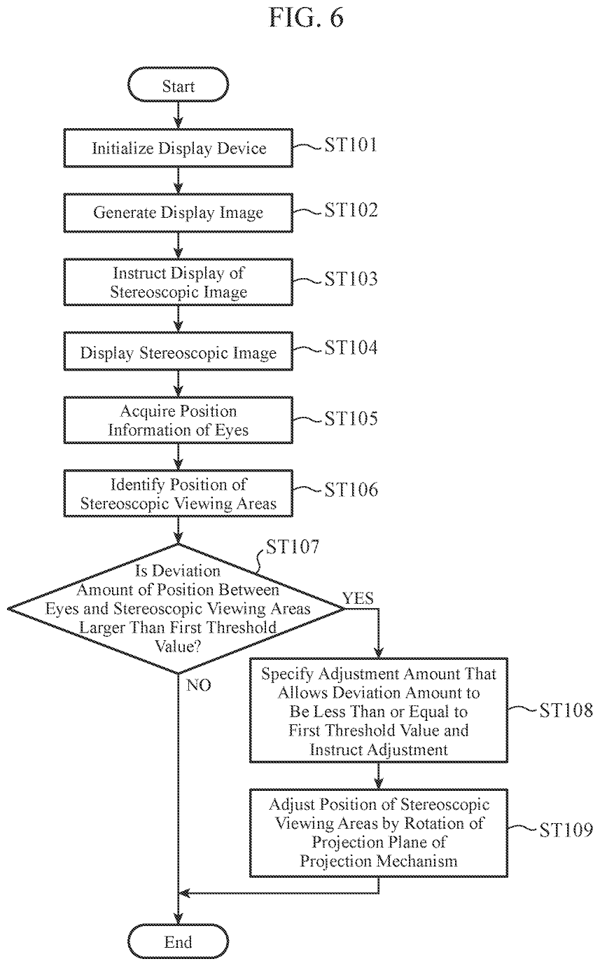

That is, the display control device 2 includes a processing circuit for executing a series of processing from step ST101 to step ST109 illustrated in FIG. 6. The processing circuit may be dedicated hardware or a central processing unit (CPU) for executing a program stored in a memory.

In a case where the processing circuit is dedicated hardware illustrated in FIG. 5A, the processing circuit 1000 corresponds to, for example, a single circuit, a composite circuit, a programmed processor, a parallel programmed processor, an application specific integrated circuit (ASIC), a field-programmable gate array (FPGA), or a combination thereof.

Each function of the image generating unit 21, the eye position information acquiring unit 22, and the stereoscopic viewing area controlling unit 23 may be implemented by separate processing circuits, or may be collectively implemented by a single processing circuit.

In the case where the processing circuit is the processor 1001 illustrated in FIG. 5B, each function of the image generating unit 21, the eye position information acquiring unit 22, and the stereoscopic viewing area controlling unit 23 is implemented by software, firmware, or a combination of software and firmware. The software or the firmware is described as a program and is stored in the memory 1002.

The processor 1001 reads and executes the program stored in the memory 1002 and thereby implements functions of each unit. That is, the display control device 2 includes the memory 1002 for storing programs execution of which by the processor 1001 results in execution of the series of processing described above. These programs cause a computer to execute the procedures or methods of the image generating unit 21, the eye position information acquiring unit 22, and the stereoscopic viewing area controlling unit 23.

The memory 1002 corresponds to a nonvolatile or volatile semiconductor memory such as a random access memory (RAM), a read only memory (ROM), a flash memory, an erasable programmable read only memory (EPROM), or an electrically-EPROM (EEPROM); a magnetic disc, a flexible disc, an optical disc, a compact disc, a mini disc, or a DVD.

Note that some of the functions of the image generating unit 21, the eye position information acquiring unit 22, and the stereoscopic viewing area controlling unit 23 may be implemented by dedicated hardware and some of them may be implemented by software or firmware.

For example, the function of the image generating unit 21 may be implemented by the processing circuit 1000 as dedicated hardware, and the functions of the eye position information acquiring unit 22 and the stereoscopic viewing area controlling unit 23 may be implemented by the processor 1001 reading and executing a program stored in the memory 1002.

In this manner, the processing circuit can implement each function described above by hardware, software, firmware, or a combination thereof.

Next, the operation will be described.

FIG. 6 is a flowchart illustrating a display control method according to the first embodiment, and illustrates a series of processing in the control of the display device 3 by the display control device 2.

First, the stereoscopic viewing area controlling unit 23 instructs the projection mechanism adjusting unit 32 to initialize the display device 3 (step ST101). By the initialization, the positions of the projection mechanism 31a, the projection plane 31a-1, and the reflection mirror 31c return to the initial positions. The stereoscopic image 201 is formed at a position corresponding to the initial positions. Note that the position of the stereoscopic image 201 that is easy for a driver to visually recognize may be stored, and the positions of the projection mechanism 31a, the projection plane 31a-1, and the reflection mirror 31c at this time may be set as the initial positions.

Next, the image generating unit 21 generates a display image on the basis of information of the inside and the outside of the vehicle input from the information source devices 4 (step ST102). For example, the image generating unit 21 sets a display mode of a display object on the basis of the information of the inside and the outside of the vehicle, and generates the display image representing the display object in the set display mode. Two display images in which a parallax of the left eye and the right eye is given to the display object are obtained as binocular parallax images. Note that examples of the display mode include the size of the display object, the position of the display object, the color of the display object, and the amount of parallax in the parallax images.

The image generating unit 21 instructs the stereoscopic image display unit 31 to display the stereoscopic image 201 of the display image (step ST103).

The stereoscopic image display unit 31 displays the stereoscopic image 201 of the display image in accordance with the instruction from the image generating unit 21 (step ST104). First, the stereoscopic image display unit 31 projects display light of the display image input from the image generating unit 21 from the projection plane 31a-1 of the projection mechanism 31a. The display light of the display image is split into display light of the left-eye image 200L and display light of the right-eye image 200R by the spectroscopic mechanism 31b, and projected onto the windshield 300 by the reflection mirror 31c. From the driver's viewpoint, the stereoscopic image 201 including the left-eye stereo image 201L and the right-eye stereo image 201R is formed through the windshield 300. In a case where the display image includes binocular parallax images, the driver can visually recognize the stereoscopic display object 203 by the effect of parallax. In this manner, “display of a stereoscopic image” means that a stereoscopic image is formed at a desired position when viewed from the driver's viewpoint.

In order for the driver to visually recognize the stereoscopic display object 203, it is necessary that the display object 202L of the left-eye stereo image 201L be visually recognized by the left eye 100L in the stereoscopic viewing area 23L for the left eye and that the display object 202R of the right-eye stereo image 201R be visually recognized by the right eye 100R in the stereoscopic viewing area 23R for the right eye. For this reason, when the position of the driver's eyes is out of the stereoscopic viewing areas, the driver cannot visually recognize the stereoscopic display object 203. In addition, when the position of the driver's eyes is close to the boundary of the stereoscopic viewing areas, there is a high possibility that the position of the driver's eyes deviates from the stereoscopic viewing areas due to the movement of the driver's head.

Therefore, the display control device 2 executes the following series of processing. The series of processing may be performed before driving of the vehicle 1 or may be performed at all times while the vehicle 1 is being driven.

The eye position information acquiring unit 22 acquires position information of the driver's eyes from image information of the driver photographed by the onboard camera 41 (step ST105).

For example, the eye position information acquiring unit 22 acquires position information of the left eye 100L and the right eye 100R of the driver by analyzing the image information and estimating the position of the face of the driver.

The position information of the left eye 100L and the right eye 100R of the driver may be position coordinates of each of the left eye 100L and the right eye 100R, or may be position coordinates of the midpoint between the left eye 100L and the right eye 100R. Hereinafter, the position coordinates of the midpoint between the left eye 100L and the right eye 100R are used as the position information of the left eye 100L and the right eye 100R of the driver.

The stereoscopic viewing area controlling unit 23 acquires, from the projection mechanism adjusting unit 32, information indicating the rotation angle from the reference position of the projection mechanism adjusting unit 32 that rotates the projection plane 31a-1 about the vertical axis 31a-2, and specifies the positions of the stereoscopic viewing areas 23L and 23R on the basis of the acquired information (step ST106). For example, a projection optical system may be designed in advance to prepare a database in which the rotation angle of the projection mechanism adjusting unit 32 for rotating the projection plane 31a-1 is associated with the positions of the stereoscopic viewing areas. The stereoscopic viewing area controlling unit 23 may specify the positions of the stereoscopic viewing areas by referring to the database.

Alternatively, the stereoscopic viewing area controlling unit 23 may specify the positions of the stereoscopic viewing areas from a calculation formula using the rotation angle of the projection mechanism adjusting unit 32.

Next, the stereoscopic viewing area controlling unit 23 determines whether the deviation amount between the positions of the driver's eyes acquired by the eye position information acquiring unit 22 and the positions of the stereoscopic viewing areas 23L and 23R specified in step ST106 is larger than the first threshold value (step ST107).

The first threshold value is a threshold value related to the deviation amount that is adjustable by rotation of the projection plane 31a-1 about the vertical axis 31a-2 by the projection mechanism adjusting unit 32. The deviation amount to be compared with the first threshold value corresponds to the deviation amount in the left-right direction and the front-rear direction of the stereoscopic viewing areas 23L and 23R, and the first threshold value is a tolerable value of the deviation amount in the left-right direction and the front-rear direction.

If the deviation amount is less than or equal to the first threshold value (step ST107; NO), the stereoscopic viewing area controlling unit 23 ends the processing of FIG. 6 without adjusting the positions of the stereoscopic viewing areas.

On the other hand, if it is determined that the deviation amount is larger than the first threshold value (step ST107; YES), the stereoscopic viewing area controlling unit 23 specifies the rotation angle of the projection mechanism adjusting unit 32 at which the deviation amount becomes less than or equal to the first threshold value and instructs the projection mechanism adjusting unit 32 to perform adjustment (step ST108).

For example, the stereoscopic viewing area controlling unit 23 calculates a rotation angle at which the deviation amount becomes less than or equal to the first threshold value and becomes the minimum. Alternatively, a database may be prepared in which the rotation angle at which the deviation amount becomes less than or equal to the first threshold value is registered, and the stereoscopic viewing area controlling unit 23 may specify the adjustment amount by referring to the database.

The projection mechanism adjusting unit 32 adjusts the positions of the stereoscopic viewing areas 23L and 23R by rotating the projection plane 31a-1 about the vertical axis 31a-2 at the rotation angle instructed by the stereoscopic viewing area controlling unit 23 (step ST109). By this position adjustment, the left eye 100L of the driver is positioned near the center of the stereoscopic viewing area 23L for the left eye, and the right eye 100R of the driver is positioned near the center of the stereoscopic viewing area 23R for the right eye. As a result, the driver can stereoscopically view the stereoscopic display object 203 even when the head moves a little.

The series of processing illustrated in FIG. 6 returns to step ST102 and the subsequent processing is repeated unless the engine of the vehicle 1 is turned off or execution of the above processing by the display control device 2 is stopped. Note that, in the case where a previous display image is continued to be displayed, the flow may return to the processing of step ST105 and the subsequent processing may be repeated.

As described above, the display control device 2 according to the first embodiment adjusts the positions of the stereoscopic viewing areas 23L and 23R depending on the position information of the left eye 100L and the right eye 100R of the driver by rotating the projection plane 31a-1 about the vertical axis 31a-2 passing through the center position of the projection plane 31a-1 of the projection mechanism 31a.

In particular, the stereoscopic viewing area controlling unit 23 instructs the projection mechanism adjusting unit 32 to rotate the projection plane 31a-1 about the vertical axis 31a-2 so that the deviation amount between the positions of the stereoscopic viewing areas 23L and 23R and the position of the left eye 100L and the right eye 100R of the driver becomes less than or equal to the first threshold value relating to the deviation amount adjustable by the rotation of the projection plane 31a-1 about the vertical axis 31a-2 by the projection mechanism adjusting unit 32.

With this configuration, the positions of the stereoscopic viewing areas 23L and 23R can be adjusted depending on the position of the eyes of the driver with a configuration simpler than a configuration for controlling a spectroscopic mechanism.

### Second Embodiment

The first embodiment has illustrated the configuration for adjusting the positions of the stereoscopic viewing areas in the left-right direction and the front-rear direction; however, in addition to this, a configuration for adjusting the position of stereoscopic viewing areas in the up-down direction will be described in a display control device according to a second embodiment.

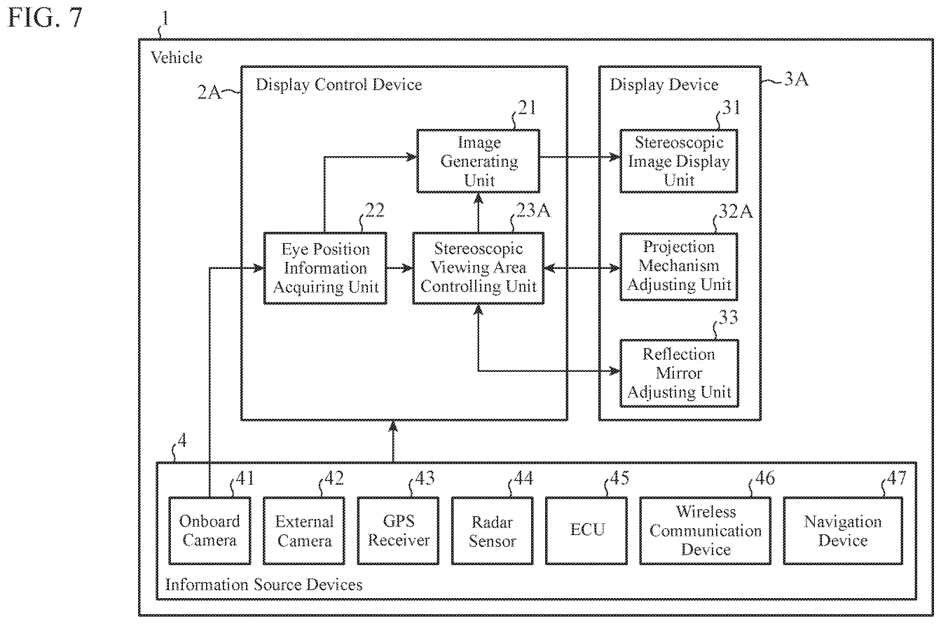

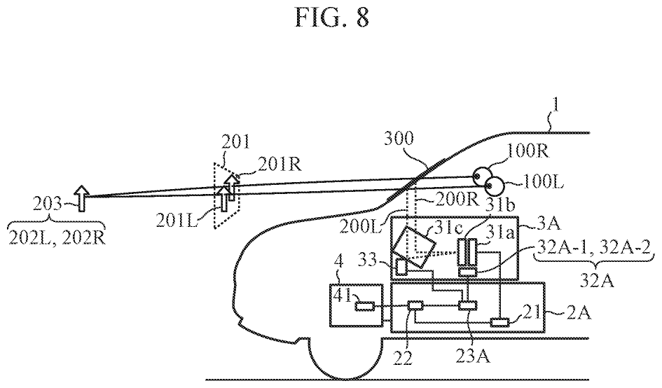

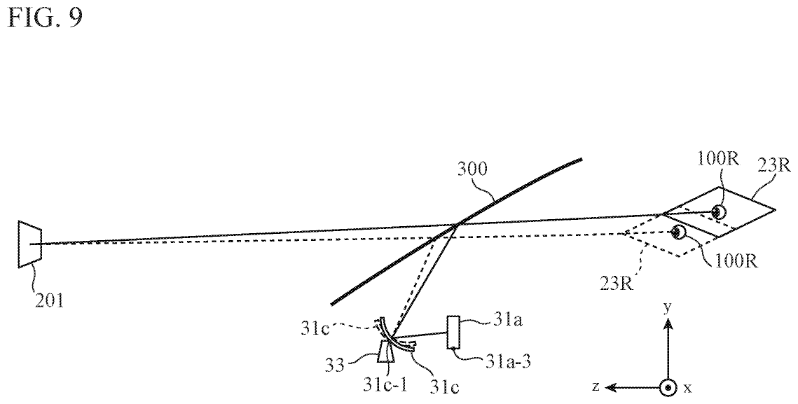

FIG. 7 is a functional block diagram illustrating a configuration of a display system according to a second embodiment of the invention. FIG. 8 is a diagram schematically illustrating a configuration of the display system according to the second embodiment mounted on a vehicle 1 and illustrates a case where the display system of the second embodiment is implemented as an HUD system. In FIGS. 7 and 8, the same component as that in FIG. 1 or 2 is denoted with the same symbol, and their descriptions are omitted. FIG. 9 is a diagram illustrating an outline of position adjustment of a stereoscopic viewing area by a projection mechanism adjusting unit 32A and a reflection mirror adjusting unit 33.

As illustrated in FIGS. 7 and 8, the display system according to the second embodiment includes a display control device 2A and a display device 3A.

The display control device 2A controls the display device 3A to adjust the position of a stereoscopic viewing area in the up-down direction in addition to the left-right and front-rear directions.

The display control device 2A includes an image generating unit 21, an eye position information acquiring unit 22, and a stereoscopic viewing area controlling unit 23A as components. The display device 3A is a display device that causes a driver to stereoscopically view binocular parallax images, and includes a stereoscopic image display unit 31, the projection mechanism adjusting unit 32A, and the reflection mirror adjusting unit 33.

In addition to the rotation angle of the projection mechanism adjusting unit 32A-1 that rotates the projection plane 31a-1 about the vertical axis 31a-2 illustrated in FIG. 4, the stereoscopic viewing area controlling unit 23A specifies the positions of the stereoscopic viewing areas 23L and 23R on the basis of at least one of the rotation angle of a reflection mirror 31c or the rotation angle of a projection mechanism adjusting unit 32A-2.

The rotation angle of the reflection mirror 31c corresponds to, as illustrated in FIG. 9, the rotation angle with respect to a reference position when the reflection mirror 31c is rotated about a horizontal axis 31c-1 passing through the fulcrum of the reflection mirror 31c. Here, the reference position is the origin position of the rotation of the reflection mirror 31c.

The projection mechanism adjusting unit 32A includes the projection mechanism adjusting unit 32A-1 and the projection mechanism adjusting unit 32A-2. The projection mechanism adjusting unit 32A-1 is a component that adjusts the projection direction of the projection mechanism 31a, and is a motor that rotates, for example, the projection plane 31a-1 about the vertical axis 31a-2 like the projection mechanism adjusting unit 32 in the first embodiment. Meanwhile, the projection mechanism adjusting unit 32A-2 is an adjusting unit that moves the projection mechanism 31a in the optical axis direction, and is a motor that rotates about a horizontal axis 31a-3 for example to move the projection mechanism 31a in the optical axis direction.

The rotation angle of the projection mechanism adjusting unit 32A-2 corresponds to the rotation angle with respect to a reference position of the projection mechanism adjusting unit 32A-2 when the projection mechanism adjusting unit 32A-2 moves the projection plane 31a-1 in the optical axis direction from a reference position. Here, the reference position of the projection mechanism adjusting unit 32A-2 refers to the origin position of the rotation of the projection mechanism adjusting unit 32A-2.

When the projection mechanism 31a moves in the optical axis direction, the position at which a stereoscopic image 201 is formed moves in the front-rear and up-down directions accordingly. Depending on the front-rear and up-down movements of the position, stereoscopic viewing areas 23L and 23R also move in the front-rear and up-down directions (z direction and y direction in FIG. 9). That is, it is possible to adjust the positions of the stereoscopic viewing areas 23L and 23R in the front-rear and up-down directions by moving the projection mechanism 31a in the optical axis direction.

The reflection mirror adjusting unit 33 is a component that adjusts the reflection direction of the reflection mirror 31c, and is capable of rotating, for example, the reflection mirror 31c about the horizontal axis 31c-1.

When the reflection mirror 31c rotates about the horizontal axis 31c-1, the stereoscopic image 201 also moves in the front-rear and up-down directions accordingly. Depending on this movement, the stereoscopic viewing area 23L for the left eye and the stereoscopic viewing area 23R for the right eye also move in the front-rear and up-down directions (y direction in FIG. 9) as illustrated in FIG. 9.

That is, it is possible to adjust the positions of the stereoscopic viewing areas 23L and 23R in the front-rear and up-down directions by rotating the reflection mirror 31c about the horizontal axis 31c-1.

A stereoscopic viewing area is a space formed on the driver side and spreading in the front-rear, left-right, and up-down directions, and it is expected that the shape is not uniform in the front-rear, left-right, and up-down directions.

For example, a cross-sectional area obtained by cutting a stereoscopic viewing area in the horizontal direction varies depending on the position in the vertical direction, and the driver's eyes can easily deviate from the stereoscopic viewing areas at a position where the cross-sectional area is small.

Therefore, in the second embodiment, in addition to the rotation angle of the projection mechanism adjusting unit 32A-1 that rotates the projection plane 31a-1 about the vertical axis 31a-2, the positions of the stereoscopic viewing areas 23L and 23R are specified on the basis of at least one of the rotation angle of the reflection mirror 31c or the rotation angle of the projection mechanism adjusting unit 32A-2 (movement of the projection mechanism 31a in the optical axis direction). As a result, it is possible to adequately specify the positions of the stereoscopic viewing areas 23L and 23R in the front-rear direction, the left-right direction, and the up-down direction and to adjust the positions of the stereoscopic viewing areas so that the driver's eyes do not deviate.

Since the positions of the stereoscopic viewing areas are adjusted depending on the position of the driver's eyes in the display control device 2A, the position of the stereoscopic image 201 is automatically adjusted in the front-rear, left-right, and up-down directions to a position that the driver can easily view.

Note that the display control device 2A may be configured to allow a driver to manually set the position of the stereoscopic image 201. For example, the driver operates the projection mechanism adjusting unit 32A-2 and the reflection mirror adjusting unit 33 using an input device (not illustrated) to manually set the stereoscopic image 201 at a position that the driver can easily view.

Each function of the image generating unit 21, the eye position information acquiring unit 22, and the stereoscopic viewing area controlling unit 23A in the display control device 2A illustrated in FIG. 7 is implemented by a processing circuit.

That is, the display control device 2A includes a processing circuit for executing these functions.

The processing circuit may be dedicated hardware as illustrated in FIG. 5A or may be a processor that executes a program stored in a memory as illustrated in FIG. 5B.

In addition, the display control device 2A may perform display control as follows.

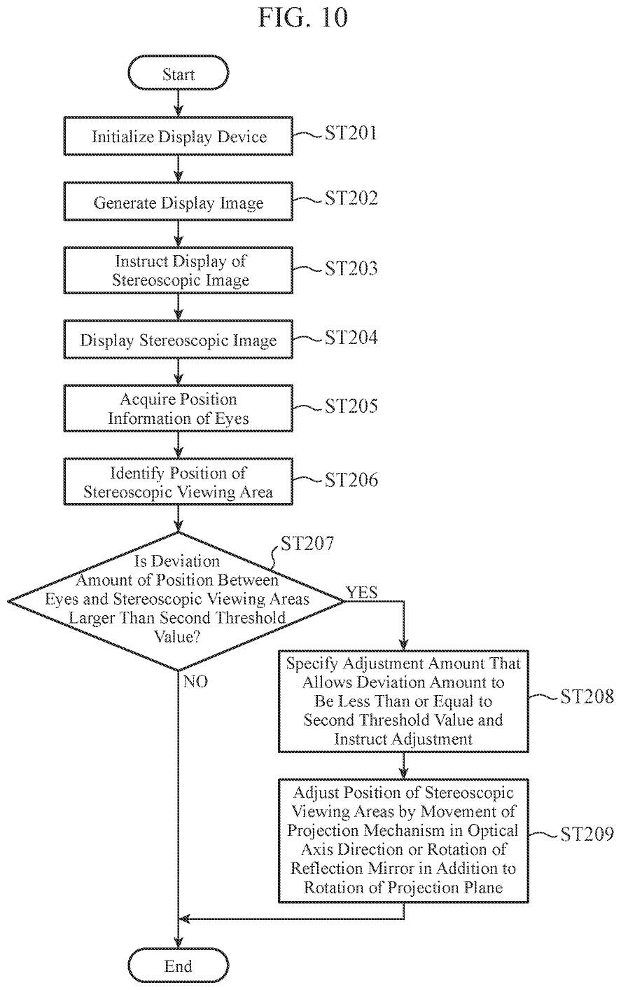

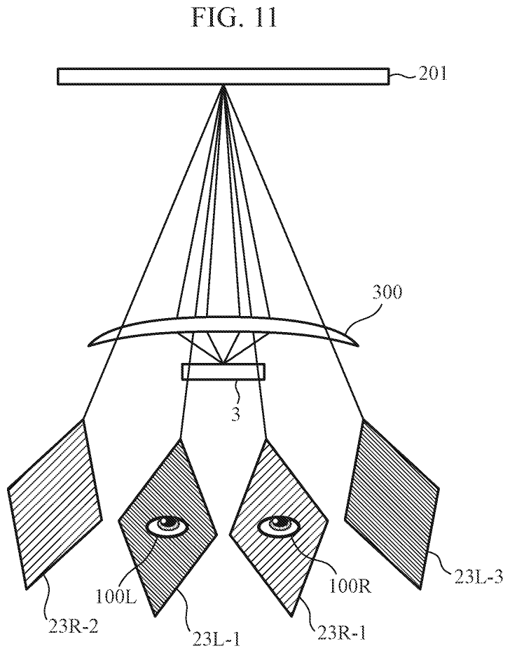

FIG. 10 is a flowchart illustrating a display control method according to the second embodiment, and illustrates a series of processing in the control of the display device 3A by the display control device 2A.

Processing from step ST201 to step ST205 in FIG. 10 is similar to the processing from step ST101 to step ST105 in FIG. 6, and thus description thereof is omitted.

In step ST206, the stereoscopic viewing area controlling unit 23A acquires, from the projection mechanism adjusting unit 32A-1, information indicating the rotation angle with respect to the reference position of the projection plane 31a-1 about the vertical axis 31a-2 and further acquires information indicating the rotation angle with respect to the reference position about the horizontal axis 31a-3 from the projection mechanism adjusting unit 32A-2 or acquires information indicating the rotation angle with respect to the reference position of the reflection mirror 31c about the horizontal axis 31c-1 from the reflection mirror adjusting unit 33.

The stereoscopic viewing area controlling unit 23A specifies the positions of the stereoscopic viewing areas 23L and 23R on the basis of at least one of the rotation angle of the reflection mirror 31c or the rotation angle of the projection mechanism adjusting unit 32A-2 in addition to the rotation angle of the projection mechanism adjusting unit 32A-1 that rotates the projection plane 31a-1 about the vertical axis 31a-2.

For example, a projection optical system may be designed in advance to prepare a database in which the rotation angle of the projection mechanism adjusting unit 32A-1, the rotation angle of the projection mechanism adjusting unit 32A-2 or the rotation angle of the reflection mirror 31c, and the position of stereoscopic viewing areas are associated. The stereoscopic viewing area controlling unit 23A may specify the positions of the stereoscopic viewing areas by referring to the database.

Alternatively, the stereoscopic viewing area controlling unit 23A may specify the positions of the stereoscopic viewing areas from a calculation formula using the rotation angle of the projection mechanism adjusting unit 32A-1 and the rotation angle of the projection mechanism adjusting unit 32A-2 or the rotation angle of the reflection mirror 31c.

Next, the stereoscopic viewing area controlling unit 23A determines whether the deviation amount between the position of the driver's eyes acquired by the eye position information acquiring unit 22 and the positions of the stereoscopic viewing areas 23L and 23R specified in step ST206 is larger than a second threshold value (step ST207).

The second threshold value is a threshold value related to the deviation amount that is adjustable by the rotation of the projection plane 31a-1 about the vertical axis 31a-2 by the projection mechanism adjusting unit 32A-1, the movement of the projection mechanism 31a in the optical axis direction by the projection mechanism adjusting unit 32A-2 or the rotation of the reflection mirror 31c. The deviation amount to be compared with the second threshold value corresponds to the deviation amount of the stereoscopic viewing areas 23L and 23R in the left-right direction, the front-rear direction, and the up-down direction, and the second threshold value includes a tolerable value of the deviation amount in the up-down direction in addition to the tolerable value of the deviation amount in the left-right direction and the front-rear direction.

If the deviation amount is less than or equal to the second threshold value (step ST207; NO), the stereoscopic viewing area controlling unit 23A ends the processing of FIG. 10 without adjusting the positions of the stereoscopic viewing areas.

If it is determined that the deviation amount is larger than the second threshold value (step ST207; YES), the stereoscopic viewing area controlling unit 23A specifies the rotation angle of the projection mechanism adjusting unit 32A-1, the rotation angle of the projection mechanism adjusting unit 32A-2, and the rotation angle of the reflection mirror 31c at which the deviation amount becomes less than or equal to the second threshold value and instructs the projection mechanism adjusting unit 32A-1, the projection mechanism adjusting unit 32A-2, and the reflection mirror adjusting unit 33 to perform adjustment (step ST208).

For example, a projection optical system may be designed in advance to prepare a database in which the rotation angle at which the deviation amount becomes less than or equal to the second threshold value is registered, and the stereoscopic viewing area controlling unit 23A may specify the adjustment amount by referring to the database.

Alternatively, the stereoscopic viewing area controlling unit 23A may calculate the rotation angle of the projection mechanism adjusting unit 32A-1, the rotation angle of the projection mechanism adjusting unit 32A-2, and the rotation angle of the reflection mirror 31c at which the deviation amount becomes less than or equal to the second threshold value and the minimum using a calculation formula.

The positions of the stereoscopic viewing areas 23L and 23R are adjusted by executing at least one of the movement of the projection mechanism 31a in the optical axis direction by the projection mechanism adjusting unit 32A-2 and the rotation of the reflection mirror 31c about the horizontal axis 31c-1 in addition to the rotation of the projection plane 31a-1 about the vertical axis 31a-2 by the projection mechanism adjusting unit 32A-1 (step ST209). By this position adjustment, the left eye 100L of the driver is positioned near the center of the stereoscopic viewing area 23L on the left side, and the right eye 100R of the driver is positioned near the center of the stereoscopic viewing area 23R on the right side. Thus, the driver can stereoscopically view the binocular parallax images even when the head moves a little.

The series of processing illustrated in FIG. 10 returns to step ST202 and the subsequent processing is repeated unless the engine of the vehicle 1 is turned off or execution of the above processing by the display control device 2A is stopped. Note that in the case where a previous display image is continued to be displayed, the flow may return to the processing of step ST205 and the subsequent processing may be repeated.

As described above, in the display control device 2A according to the second embodiment, the stereoscopic viewing area controlling unit 23A specifies the positions of the stereoscopic viewing areas 23L and 23R on the basis of at least one of the rotation angle of the reflection mirror 31c about the horizontal axis 31c-1 or the movement of the projection mechanism 31a in the optical axis direction in addition to the rotation angle of the projection mechanism adjusting unit 32A-1 that rotates the projection plane 31a-1 about the vertical axis 31a-2.

With this configuration, it is possible to adequately specify the positions of the stereoscopic viewing areas 23L and 23R in the front-rear direction, the left-right direction, and the up-down direction and to adjust the positions of the stereoscopic viewing areas so that the driver's eyes do not deviate.

In the display control device 2A according to the second embodiment, the stereoscopic viewing area controlling unit 23A adjusts the positions of the stereoscopic viewing areas 23L and 23R by instructing the projection mechanism adjusting unit 32A-1 to rotate the projection plane 31a-1 about the vertical axis 31a-2 so that the deviation amount between the positions of the stereoscopic viewing areas 23L and 23R and the eye position of the driver's eyes becomes less than or equal to the second threshold value and further executing at least one of instructing the reflection mirror adjusting unit 33 to rotate the reflection mirror 31c about the horizontal axis 31c-1 or instructing the projection mechanism adjusting unit 32A-2 to move the projection mechanism 31a in the optical axis direction.

With this configuration, the positions of the stereoscopic viewing areas 23L and 23R can be adjusted depending on the position of the eyes of the driver with a configuration simpler than a configuration for controlling a spectroscopic mechanism.

### Third Embodiment

A display control device according to a third embodiment controls a display device 3 to display a left-eye image 200L and a right-eye image 200R by switching the images in a case where the deviation amount is larger than a third threshold value (it is assumed that the third threshold value is larger than the first threshold). Then, a right-eye image 200R is displayed in a stereoscopic viewing area 23L for the left eye, and a left-eye image 200L is displayed in a stereoscopic viewing area 23R for the right eye. That is, the stereoscopic viewing areas for the left eye and the right eye are switched. This allows the rotation angle of the projection mechanism adjusting unit 32 that rotates the projection plane 31a-1 about the vertical axis 31a-2 to be reduced in position adjustment of the stereoscopic viewing areas 23L and 23R in the front-rear and left-right directions, and thus it is possible to suppress distortion of a stereoscopic image or a change in the display mode accompanying the rotation of the projection plane 31a-1.

In a display control device according to the third embodiment, an image generating unit controls the display device 3 to display the left-eye image 200L and the right-eye image 200R by switching the images. However, the basic configuration other than this point is the same as that of the display control device 2 described in the first embodiment. Therefore, FIGS. 1 and 2 will be referred to in the following description for the configuration of the display control device according to the third embodiment.

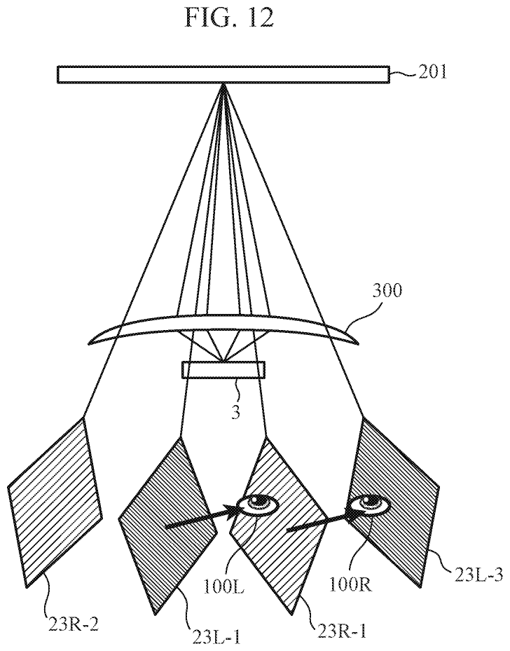

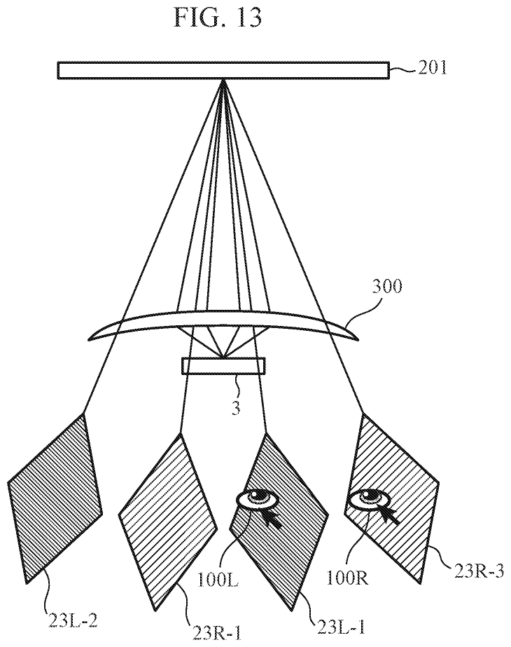

FIG. 11 is a top view illustrating stereoscopic viewing areas 23R-2, 23L-1, 23R-1, and 23L-3 formed on a driver side. FIG. 12 is a top view illustrating a situation where the driver's head is shifted to the right in the stereoscopic viewing areas of FIG. 11. FIG. 13 is a top view illustrating an outline of control processing by an image generating unit 21 in the third embodiment.

Display light of an image projected from a projection mechanism 31a is split into a plurality of directions by a spectroscopic mechanism, and as a result stereoscopic viewing areas for the left eye and stereoscopic viewing areas for the right eye are alternately arranged in the left-right direction.

For example, in the spectroscopic mechanism 31b illustrated in FIG. 3, when light is split by an opening immediately above a certain pixel, a stereoscopic viewing area 23L-1 and a stereoscopic viewing area 23R-1 are formed. Meanwhile, when light is split by an opening on the left of the opening immediately above the pixel, a stereoscopic viewing area 23R-2 is formed, and when light is split by an opening on the right of the opening immediately above the pixel, a stereoscopic viewing area 23L-3 is formed

As illustrated in FIG. 11, in the case where the stereoscopic viewing area 23L-1 for the left eye and the stereoscopic viewing area 23R-1 for the right eye are aligned, the stereoscopic viewing area 23R-2 for the right eye is formed on the left side of the stereoscopic viewing area 23L-1, and the stereoscopic viewing area 23L-3 for the left eye is formed on the right side of the stereoscopic viewing area 23R-1.

As illustrated in FIG. 12, when the driver's head moves significantly to the right, the left eye 100L of the driver moves to the stereoscopic viewing area 23R-1 for the right eye, and the right eye 100R of the driver moves to the stereoscopic viewing area 23L-2 for the left eye, thus resulting in a mismatch between the driver's eyes and the corresponding stereoscopic viewing areas. The stereoscopic viewing area 23R-1 is formed by display light of the right-eye image 200R, and the stereoscopic viewing area 23L-2 is formed by display light of the left-eye image 200L, and thus if the driver's eyes and corresponding stereoscopic viewing areas do not match, the driver cannot properly view the binocular parallax images stereoscopically. In addition, since the amount of movement for a proper stereoscopic vision increases, the amount of rotation of the projection mechanism adjusting unit 32 increases.

Therefore, the image generating unit 21 in the third embodiment controls the display device 3 to display the left-eye image 200L and the right-eye image 200R by switching the images, thereby displaying the right-eye image 200R in the stereoscopic viewing area 23L-3 for the left-eye illustrated in FIG. 12 and displaying the left-eye image 200L in the stereoscopic viewing area 23R-1 for the right eye illustrated in FIG. 12. As a result, the stereoscopic viewing areas for the left-eye and the right-eye are switched with the stereoscopic viewing area 23R-1 becoming the stereoscopic viewing area 23L-1 and the stereoscopic viewing area 23L-3 becoming the stereoscopic viewing area 23R-3 as illustrated in FIG. 13, and thus the amount of rotation of the projection mechanism adjusting unit 32 can be reduced, and distortion of the stereoscopic image or a change in the display mode can be suppressed when the driver stereoscopically views the binocular parallax images properly.

Next, the operation will be described.

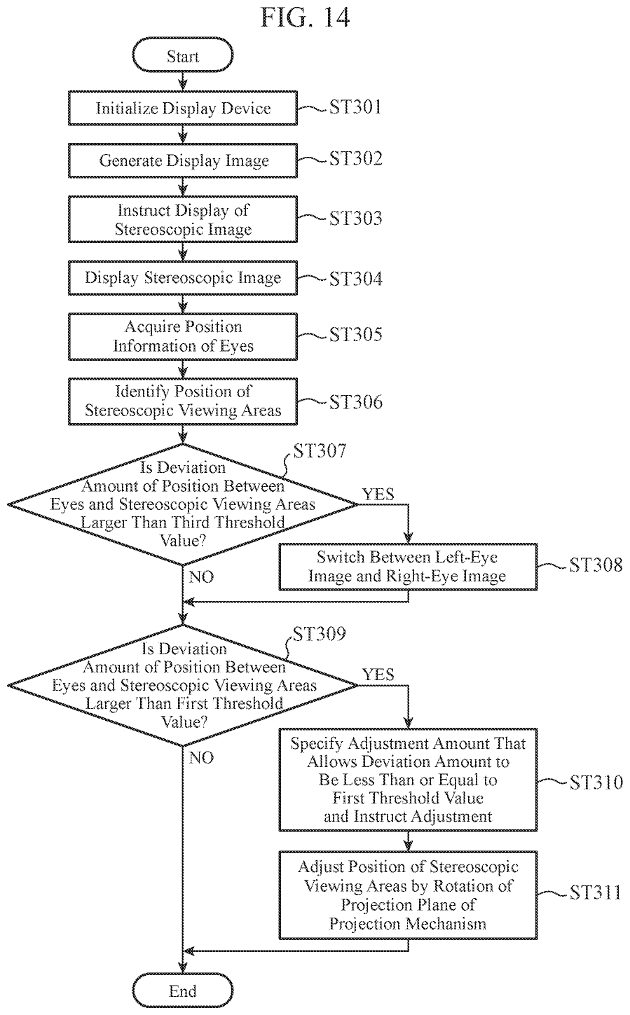

FIG. 14 is a flowchart illustrating a display control method according to the third embodiment, and illustrates a series of processing in the control of the display device 3 by the display control device 2.

Processing from step ST301 to step ST306 in FIG. 14 is similar to the processing from step ST101 to step ST106 in FIG. 6, and processing from step ST309 to step ST311 in FIG. 14 is similar to the processing from step ST107 to step ST109 in FIG. 6, and thus description thereof is omitted.

In step ST307, the stereoscopic viewing area controlling unit 23 determines whether the deviation amount between the position of the driver's eyes acquired by the eye position information acquiring unit 22 and the positions of the stereoscopic viewing areas specified in step ST306 is larger than the third threshold value. Here, the third threshold value is, for example, a threshold value related to the deviation amount of the stereoscopic viewing areas in the front-rear and left-right directions. If the deviation amount exceeds the third threshold value, a difference between the driver's eyes and the corresponding stereoscopic viewing areas as illustrated in FIG. 12 becomes large, and the amount of rotation of the projection mechanism adjusting unit 32 increases.

If the deviation amount is less than or equal to the third threshold value (step ST307; NO), the stereoscopic viewing area controlling unit 23 proceeds to the processing of step ST309.

On the other hand, if it is determined that the deviation amount is larger than the third threshold value (step ST307; YES), the stereoscopic viewing area controlling unit 23 notifies the image generating unit 21 of the fact.

When receiving the above notification from the stereoscopic viewing area controlling unit 23, the image generating unit 21 generates binocular parallax images obtained by switching the left-eye image 200L and the right-eye image 200R and causes the display device 3 to display the images (step ST308). As a result, the arrangement of the stereoscopic viewing areas for the right eye and the right-eye is switched as illustrated in FIG. 13 with the right-eye image displayed in the stereoscopic viewing area for the left eye and the left-eye image displayed in the stereoscopic viewing area for the right eye, and thus the amount of rotation of the projection mechanism adjusting unit 32 can be reduced. Thereafter, the stereoscopic viewing area controlling unit 23 specifies the positions of the stereoscopic viewing areas like in step ST305, and the flow proceeds to the processing of step ST309.

Note that the case where the display control device 2 of the first embodiment has the function of switching the stereoscopic viewing areas for the left eye and the right eye has been described in the above description; however, this function may be provided to the display control device 2A of the second embodiment.

As described above, in the display control device 2 according to the third embodiment, the image generating unit 21 controls the display device 3 to display the left-eye image 200L and the right-eye image 200R by switching the images when the deviation amount between the positions of the stereoscopic viewing areas and the position of the driver's eyes exceeds the third threshold value.

This allows the rotation angle of the projection mechanism adjusting unit 32 that rotates the projection plane 31a-1 about the vertical axis 31a-2 to be reduced in position adjustment of the stereoscopic viewing areas in the left-right directions, and thus it is possible to suppress distortion of the stereoscopic image or a change in the display mode accompanying the rotation of the projection plane 31a-1.

Although the case where the third embodiment is applied to the display control device 2 of the first embodiment has been illustrated, the third embodiment may be applied to the display control device 2A of the second embodiment.

Note that the image generating unit 21 may perform distortion correction on binocular parallax images after the position of stereoscopic viewing areas for the left eye and the right eye are adjusted in the first to third embodiments.

The image generating unit 21 may further perform correction to allow a display object in the binocular parallax images to be visually recognized in the same size as that before the adjustment after the positions of the stereoscopic viewing areas for the left eye and the right eye are adjusted.

Furthermore, the image generating unit 21 may perform correction to allow a display object in the binocular parallax images to be visually recognized at the same position as that before the adjustment after the positions of the stereoscopic viewing areas for the left eye and the right eye are adjusted.

Performing such corrections enables visibility equivalent to that of the stereoscopic display object 203 before position adjustment of the stereoscopic viewing areas.

In an HUD, distortion occurs in a stereoscopic image when the stereoscopic image is projected, and the amount of distortion, the size of a display object, and the display position also change depending on a viewing position of the driver.

Moreover, since the projection plane 31a-1 is rotated in the present invention, there is a possibility that the distortion, the size, and the position with respect to the reference position are deteriorated.

Therefore, the image generating unit 21 specifies a distortion correction value of binocular parallax images and correction values of the size and the display position of a display object on the basis of the rotation angle of the projection mechanism adjusting unit 32 acquired by the stereoscopic viewing area controlling unit 23 from the projection mechanism adjusting unit 32.

Alternatively, the image generating unit 21 specifies a distortion correction value of binocular parallax images and correction values of the size and the display position of a display object on the basis of the rotation angle of the projection mechanism adjusting unit 32A-1, the rotation angle of the projection mechanism adjusting unit 32A-2, and the rotation angle of the reflection mirror 31c acquired by the stereoscopic viewing area controlling unit 23A from the projection mechanism adjusting unit 32A-1, the projection mechanism adjusting unit 32A-2, and the reflection mirror adjusting unit 33. For example, a projection optical system may be designed in advance to prepare a database in which the above correction values are registered, and the image generating unit 21 may specify correction values by referring to the database. Alternatively, the image generating unit 21 may calculate the correction value using a calculation formula.

The image generating unit 21 performs distortion correction on the binocular parallax images using the specified distortion correction value.

Alternatively, the image generating unit 21 may perform correction of the distortion, the size, and the display position on each of a left-eye image, a right-eye image, and a display object in the left and right images using different correction tables and then combine these to generate binocular parallax images. Since viewing positions of the left eye and the right eye are different, the visibility can be further improved by using correction tables for each position.

For example, when the projection plane 31a-1 moves backward along the optical axis, the stereoscopic image 201 becomes larger than that before the movement.

Therefore, the image generating unit 21 performs correction so that the size of the stereoscopic image 201 becomes the same as that before the movement when the projection plane 31a-1 moves backward as it rotates.

Alternatively, the image generating unit 21 may correct a display object of each of the left-eye image and the right-eye image so that the display object has the same size and position as those before the movement and perform distortion correction to generate binocular parallax images.

Note that the present invention may include a flexible combination of each embodiment, a modification of any component of each embodiment, or an omission of any component in each embodiment within the scope of the present invention.

### INDUSTRIAL APPLICABILITY

A display control device according to the present invention is capable of adjusting the position of stereoscopic viewing areas depending on the position of the eyes of an observer with a configuration simpler than a configuration for controlling a spectroscopic mechanism, and thus is suitable for, for example, an HUD to be mounted on a vehicle.

### REFERENCE SIGNS LIST

1: Vehicle, 2, 2A: Display control device, 3, 3A: Display device, 4: Information source device, 21: Image generating unit, 22: Eye position information acquiring unit, 23, 23A: Stereoscopic viewing area controlling unit, 23L, 23L-1, 23L-2, 23L-3, 23R, 23R-1, 23R-2, 23R-3: Stereoscopic viewing area, 31: Stereoscopic image display unit, 31a: Projection mechanism, 31a-1: Projection plane, 31a-2: Vertical axis, 31a-3: Horizontal axis, 31b: Spectroscopic mechanism, 31c: Reflection mirror, 31c-1: Horizontal axis, 32, 32A, 32A-1, 32A-2: Projection mechanism adjusting unit, 33: Reflection mirror adjusting unit, 41: Onboard camera, 42: External camera, 43: GPS receiver, 44: Radar sensor, 45: ECU, 46: Wireless communication device, 47: Navigation device, 100L: Left eye, 100R: Right eye, 200L: Left-eye image, 200R: Right-eye image, 201: Stereoscopic image, 201L: Left-eye stereo image, 201R: Right-eye stereo image, 202L, 202R: Display object, 203: Stereoscopic display object, 300: Windshield, 1000: Processing circuit, 1001: Processor, 1002: Memory.

1. A display control device for a display device comprising:
a projection mechanism to project display light of an image from a projection plane;
a spectroscopic mechanism to split the display light into a left-eye image and a right-eye image; and
a projection mechanism adjustor to adjust a projection direction of the projection mechanism,
wherein the display device causes an observer to stereoscopically view binocular parallax images by forming stereoscopic viewing areas for a left eye and a right eye, in which a stereoscopic image projected onto a projected plane can be visually recognized, causing the left eye of the observer to visually recognize the stereoscopic image of the left-eye image as a binocular parallax image in the stereoscopic viewing area for the left eye, and causing the right eye of the observer to visually recognize the stereoscopic image of the right-eye image as a binocular parallax image in the stereoscopic viewing area for the right eye,
the display control device comprising:
an image generator to generate the image and causing the display device to display the image;
an eye position information acquirer to acquire position information of the left eye and the right eye of the observer; and
a controller to specify positions of the stereoscopic viewing areas for the left eye and the right eye on a basis of a rotation angle of the projection mechanism adjustor that rotates the projection plane about a rotation axis passing through a center position of the projection plane of the projection mechanism and adjusting the positions of the specified stereoscopic viewing areas for the left eye and the right eye by instructing the projection mechanism adjustor to rotate the projection plane about the rotation axis depending on the position information of the left eye and the right eye of the observer acquired by the eye position information acquirer.

2. The display control device according to claim 1,
wherein the controller instructs the projection mechanism adjustor to rotate the projection plane about the rotation axis so that a deviation amount between the positions of the stereoscopic viewing areas for the left eye and the right eye and positions of the left eye and the right eye of the observer becomes less than or equal to a first threshold value relating to a deviation amount that is adjustable by rotation of the projection plane about the rotation axis.

3. The display control device according to claim 2,
wherein the display device further comprises a reflection mirror for reflecting the display light projected from the projection mechanism toward the projected plane and a reflection mirror adjustor to adjust a reflection direction of the reflection mirror, and
the controller specifies the positions of the stereoscopic viewing areas for the left eye and the right eye on a basis of at least one of a rotation angle of the reflection mirror about a mirror rotation axis passing through a fulcrum of the reflection mirror or a rotation angle of the projection mechanism adjustor that moves the projection mechanism in an optical axis direction in addition to the rotation angle of the projection mechanism adjustor that rotates the projection plane about the rotation axis.

4. The display control device according to claim 3,
wherein the controller adjusts the positions of the stereoscopic viewing areas for the left eye and the right eye by instructing the projection mechanism adjustor to rotate the projection plane about the rotation axis so that a deviation amount between the positions of the stereoscopic viewing areas for the left eye and the right eye and positions of the left eye and the right eye of the observer becomes less than or equal to a second threshold value relating to a deviation amount that is adjustable by rotation of the projection plane, movement of the projection mechanism in the optical axis direction, and rotation of the reflection mirror and by further executing at least one of instructing the reflection mirror adjustor to rotate the reflection mirror about the mirror rotation axis or instructing the projection mechanism adjustor to move the projection mechanism in the optical axis direction.

5. The display control device according to claim 1,
wherein the image generator controls the display device by switching the left-eye image and the right-eye image so that the stereoscopic viewing area for the left-eye and the stereoscopic viewing area for the right-eye are switched when a deviation amount between the positions of the stereoscopic viewing areas for the left eye and the right eye and positions of the left eye and the right eye of the observer exceeds a third threshold value relating to a deviation amount of the stereoscopic viewing areas in a left-right direction.

6. The display control device according to claim 1,
wherein the image generator performs distortion correction on the binocular parallax images after positions of the stereoscopic viewing areas for the left eye and the right eye are adjusted.

7. The display control device according to claim 1,
wherein the image generator performs correction to allow a display object in the binocular parallax images to be visually recognized in a same size as that before the adjustment after positions of the stereoscopic viewing areas for the left eye and the right eye are adjusted.

8. The display control device according to claim 1,
wherein the image generator performs correction to allow a display object in the binocular parallax images to be visually recognized at a same position as that before the adjustment after positions of the stereoscopic viewing areas for the left eye and the right eye are adjusted.

9. A display system comprising:
a display device comprising:
a projection mechanism for projecting display light of an image from a projection plane;
a spectroscopic mechanism for splitting the display light into a left-eye image and a right-eye image; and
a projection mechanism adjustor to adjust a projection direction of the projection mechanism,
wherein the display device causes an observer to stereoscopically view binocular parallax images by forming stereoscopic viewing areas for a left eye and a right eye, in which a stereoscopic image projected onto a projected plane can be visually recognized, causing the left eye of the observer to visually recognize the stereoscopic image of the left-eye image as a binocular parallax image in the stereoscopic viewing area for the left eye, and causing the right eye of the observer to visually recognize the stereoscopic image of the right-eye image as a binocular parallax image in the stereoscopic viewing area for the right eye; and
a display control device comprising:
an image generator to generate the image and causing the display device to display the image;
an eye position information acquirer to acquire position information of the left eye and the right eye of the observer; and
a controller to specify positions of the stereoscopic viewing areas for the left eye and the right eye on a basis of a rotation angle of the projection mechanism adjustor that rotates the projection plane about a rotation axis passing through a center position of the projection plane of the projection mechanism and adjusting the positions of the specified stereoscopic viewing areas for the left eye and the right eye by instructing the projection mechanism adjustor to rotate the projection plane about the rotation axis depending on the position information of the left eye and the right eye of the observer acquired by the eye position information acquirer.

10. A display control method for a display device comprising:
a projection mechanism for projecting display light of an image from a projection plane;
a spectroscopic mechanism for splitting the display light into a left-eye image and a right-eye image; and
a projection mechanism adjusting unit for adjusting a projection direction of the projection mechanism,
wherein the display device causes an observer to stereoscopically view binocular parallax images by forming stereoscopic viewing areas for a left eye and a right eye, in which a stereoscopic image projected onto a projected plane can be visually recognized, causing the left eye of the observer to visually recognize the stereoscopic image of the left-eye image as a binocular parallax image in the stereoscopic viewing area for the left eye, and causing the right eye of the observer to visually recognize the stereoscopic image of the right-eye image as a binocular parallax image in the stereoscopic viewing area for the right eye,
the display control method comprising:
generating the image and causing the display device to display the image;
acquiring position information of the left eye and the right eye of the observer; and
specifying positions of the stereoscopic viewing areas for the left eye and the right eye on a basis of a rotation angle of the projection mechanism adjusting unit that rotates the projection plane about a rotation axis passing through a center position of the projection plane of the projection mechanism and adjusting the positions of the specified stereoscopic viewing areas for the left eye and the right eye by instructing the projection mechanism adjusting unit to rotate the projection plane about the rotation axis depending on the position information of the left eye and the right eye of the observer acquired by the eye position information acquiring unit.
